(19) United States
(12) Patent Application Publication
(10) Pub. No.: US 2005/0108359 A1
(43) Pub. Date: May 19, 2005

(54) Remote mail management system

(76) Inventors: Robert Hyder, Marietta, GA (US); Alfred Adler, Roswell, GA (US); Amanda Lyons, Atlanta, GA (US); Richard McConnell, Young Harris, GA (US); Vinay Modak, Alpharetta, GA (US); John Moore, Kennesaw, GA (US); Alicia Paul, Suwanee, GA (US); Hrishi Talwar, Atlanta, GA (US)

Correspondence Address: BRYAN W. BOCKHOP, ESQ.;ARNALL GOLDEN GREGORY LLP, 171 17TH STREET, SUITE 2100, ATLANTA, GA, 30363, US

(21) Appl. No.: 10/701,886

(22) Filed: Nov. 5, 2003

(51) Int. Cl. G06F 15/16

(52) U.S. Cl. 709/217

(57) ABSTRACT

In a method for reducing notifications associated with incoming emails destined to a user using a wireless device, after receiving an incoming email, a relay server checks whether there is undelivered email destined to the user. If there is no undelivered email, then a notification is sent to the user's wireless device. If there are undelivered emails, then the relay server calculates a lapse time since the last notification was sent to the user. If the lapse time is greater than a predefined period, a notification is sent to the user.

### BACKGROUND OF THE INVENTION

1. Field of the Invention

The invention relates to computer communications and, more specifically, a system for transmitting e-mail to wireless devices.

2. Description of the Related Art

There is an increasing demand for business people, professionals and ordinary consumers to have greater access to communications while on the move. Paging systems have become very popular for communications, enabling a user to carry a lightweight, low cost device that has good wide-area and in-building penetration. In the past, paging systems have suffered from the disadvantage of being one-way only, but recently several asymmetric two-way paging systems that enable a user to respond to incoming messages have been introduced. Asymmetric systems are particularly beneficial for sending out to the pager a volume of data that exceed the volume expected to be sent back. They are particularly suited to the sending back of short acknowledgments or tags identifying “canned” responses (such as “OK” or “I'm unable to reply right now”).

Simultaneously with the development of asymmetric two-way paging systems, symmetric two-way data systems, such as the ARDIS™ system, have been developed, enabling significant volumes of data to be sent in both directions over a nationwide public data system.

With advent of 3^{rd} generation (3G) wireless communication technology, more bandwidth has become available for wireless communications, and wireless telecommunication devices, such as cellular telephones, pagers, personal digital assistants (PDAs) have increasing wireless capabilities. The wireless devices are increasingly being used not only for voice communications but also data communications. Now it is common for users to send and receive electronic mails from their handsets. Now, users can request their electronic mail server to notify them about incoming electronic mail by sending a notification message to their mobile devices. A user is notified, through a notification message received by their mobile device about a new electronic mail, and the user can decide whether he wants to download the electronic mail for reading. The notification process is repeated for every incoming message even if the user is unable to read it for the time being. This continuing notification increases traffic volume on the wireless communication network and may increase costs for the user.

### SUMMARY OF THE INVENTION

In one aspect, the invention is a method for a relay server to provide electronic mail notification to a mobile device, wherein the mobile device is in communication with the relay server via a wireless communication network. The mobile device communicates with the relay server according to a predefined protocol. The method includes receiving an electronic mail from the mail server and saving the received electronic mail on the relay server. If there is no undelivered electronic mail destined to the mobile device on the relay server, the relay server sends a new message notification to the mobile device and marks the received electronic mail as undelivered. The relay server also sets the time of a last new message notification to the current time. If there is at least one undelivered electronic mail destined to the mobile device at the relay server, the relay server calculates a lapse time between the time of last new message notification sent to the mobile device and the current time. If the lapse time is larger than a predefined period, the relay server sends a new message notification to the mobile device, marks the received electronic mail as undelivered, and sets the time of last new message notification to the current time.

In another aspect, the invention is a method for a relay server to provide a list of electronic mails to a mobile device according to a request received from the mobile device. The mobile device communicates with the electronic mail server via a wireless communication network, and the mobile device also communicates with the electronic mail server according to a predefined protocol. The method includes the steps of receiving a request, which includes a specification for electronic mails, from the mobile device, compiling a list of electronic mails according to the specification, and transmitting the list to the mobile device.

In yet another aspect, the invention is a method for scheduling a meeting for a user using a mobile device, wherein the mobile device is in communication with a server via a wireless communication network. The server receives a meeting request message from the mobile device, the meeting request message containing a request for a meeting and being destined to at least one recipient, and forwards the meeting request message to the at least one recipient. The server receives a meeting reply message from the at least one recipient, and, if at least one recipient has accepted the meeting, then the server adds the meeting to a calendar file for the at least one recipient. Finally, the server forwards the meeting reply message to the mobile device.

### BRIEF DESCRIPTION OF THE DRAWINGS

FIG. 1 is a schematic diagram of an existing wireless communication network.

FIG. 2 is a schematic diagram of a firewall protected network connected to the wireless communication network.

FIG. 3 is a block diagram for a relay server.

FIG. 4 is a communication diagram across the firewall between a mail server and a mobile device.

FIG. 5 is a flow chart for the mail server receiving an incoming electronic mail.

FIG. 6 is a flow chart for the mail server receiving a retrieval request.

FIG. 7 is a flow chart for the mail server receiving a catch-up request.

FIG. 8 is a flow chart for the mail server receiving a meeting request message.

### DETAILED DESCRIPTION OF THE INVENTION

In this description, the terms “communication device,” “wireless device,” “wireless telephone,” “wireless communications device,” “mobile device,” “mobile terminal,” and “wireless handset” are used interchangeably, and the terms “electronic mail,” “email,” and “mail” are used interchangeably. Further, like numerals refer to like elements throughout the several views.

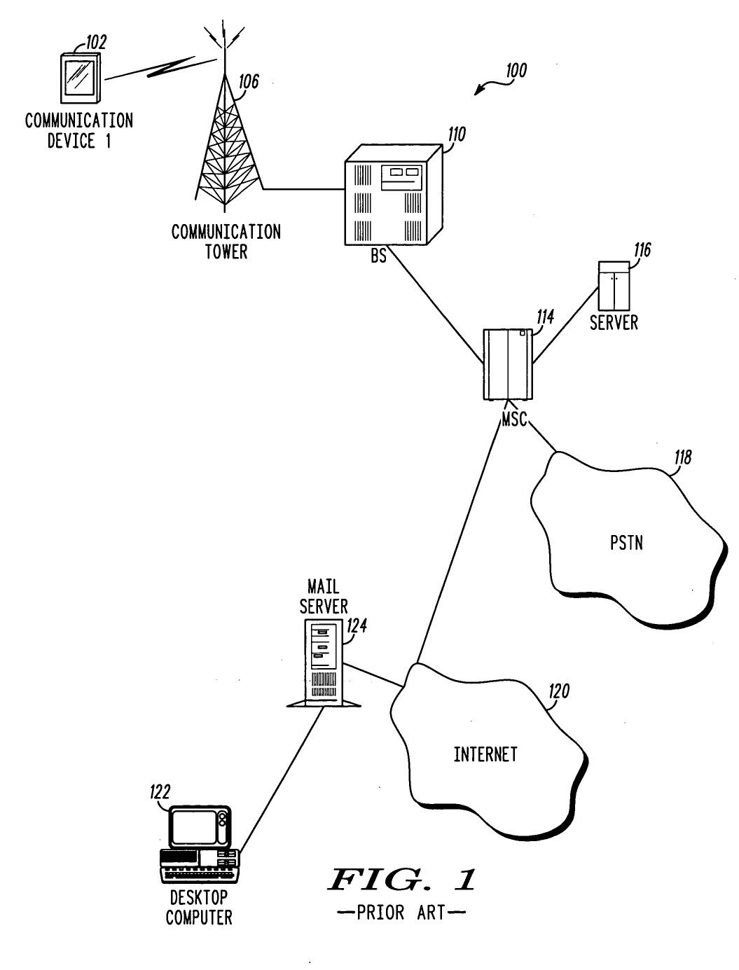

FIG. 1 depicts a wireless telecommunication network 100. The communication network 100 includes one or more communication towers 106, each connected to a base station 110 and serving users with wireless devices 102. The wireless devices 102 can be cellular telephones, pagers, personal digital assistants (PDAs), laptop computers, or other hand-held, stationary, or portable communication devices that use a wireless and cellular telecommunication network. The commands and data input by each user are transmitted as digital data to a communication tower 106. The communication between a user using a wireless device 102 and the communication tower 106 can be based on different technologies, such code division multiplexed access (CDMA), time division multiplexed access (TDMA), frequency division multiplexed access (FDMA), the global system for mobile communications (GSM), or other protocols that may be used in a wireless communications network or a data communications network. The data from each user is sent from the communication tower 106 to a base station 110, and forwarded to a mobile switching center (MSC) 114, which can be connected to a public switched telephone network (PSTN) 118 and the Internet 120. The wireless subscribers can be identified by mobile identification number (MIN) or the wireless device's electronic identification number (EIN).

The MSC 114 may be connected to a server 116 that supports different applications, including a mail relay service, available to subscribers using the wireless communications devices 102. The server 116 may also be connected to the Internet 120 and operated by a third party.

The server 116, when acting as a mail relay server, receives electronic mails and notifications from a mail server 124 on the Internet 120. The mail server 124 may serve many users using computers 122 on a network.

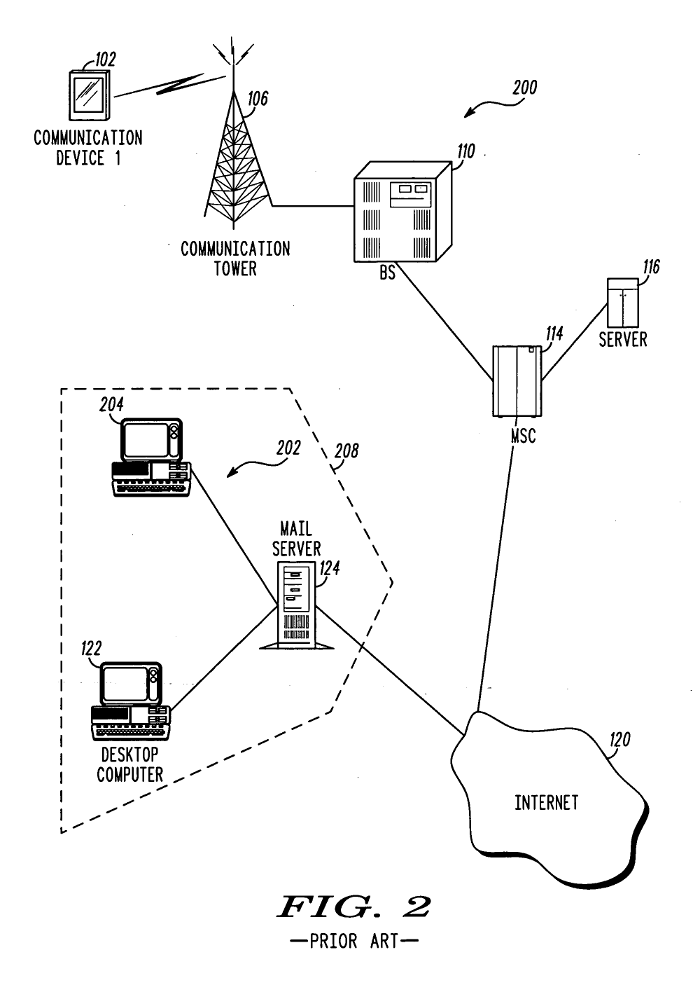

FIG. 2 depicts a local area network 202 protected from a firewall 208 and connected to the Internet 120. The firewall 208 may be implemented on the mail server 124 or on another server that sits between the mail server 124 and the Internet 120. A user at computer 122 may send an electronic mail (email) to a user at computer 204 within the local area network 202. When the user at the computer 204 is away from his desk, he can set up his computer 204, so his emails can also be forwarded to his wireless device 102. When a user at computer 122 sends an email to the user at the computer 204, the email arrives at the computer 204 and is forwarded to the wireless device 102.

The email is sent through the mail server 124 to a relay server 116 that is associated with the user's wireless service provider. The email is stored in the relay server 116 and a notification is sent to the wireless device 102. When the user is ready to read the email, the email is delivered by the relay server 116 to the wireless device 102. The body of the email may be encrypted before being transmitted outside of the firewall for security protection. After its delivery to the wireless device 102, the email is decrypted by the wireless device 102.

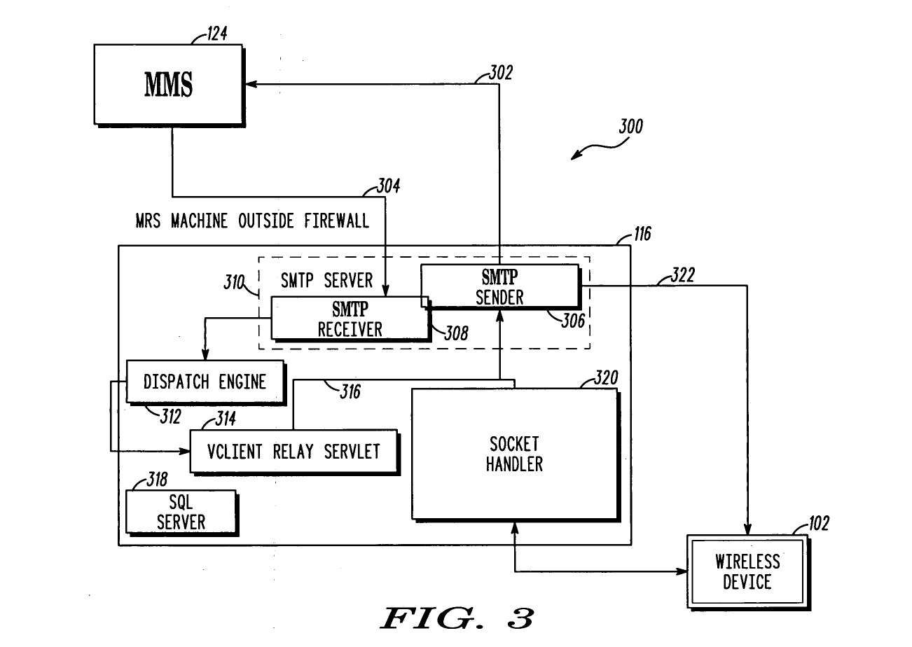

FIG. 3 is a block diagram 300 of a relay server 116 interacting with the mail server 124 and the wireless device 102. When an email is addressed to a user originally at computer 204 within a private network and the user has requested that his email be forwarded to a wireless device 102 outside of the private network, the mail server 124 checks its record, retrieves the forwarding information, encrypts the email, and sends the encrypted email to the wireless device 102. The email is received by a relay server 116 that belongs to a wireless service provider serving the wireless device 102. Generally, the email is sent using Simple Mail Transfer Protocol (SMTP), but other protocols can also be used. After the email is received by an SMTP receiver 308 within the relay server 116, the relay server 116 generates a notification. The notification is sent to the wireless device 102 and the email is stored at the relay server 116 waiting to be downloaded to the wireless device 102.

When the user is ready to read his email, the wireless device 102 opens a socket to the relay server 116 to download the emails. The open socket request is handled by the socket handler 320. The emails are sent by the SMTP sender 306.

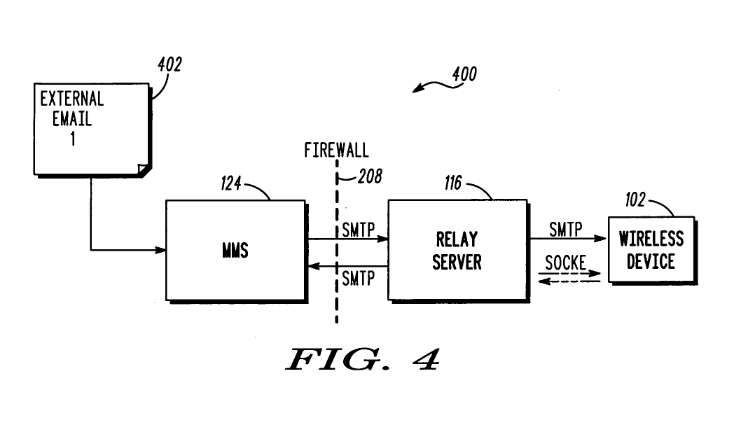

FIG. 4 illustrates communication between the mail server 124, the relay server 116, and the wireless device 102. When an email 402 arrives at the mail server 124, the mail server 124 sends the email to the relay server 116. The relay server 116 stores the message and generates and sends a notification to the wireless device 102.

When the wireless device 102 is ready to receive the email, it opens a socket connection to the relay server 116, and the relay server 116 sends the emails to the wireless device 102. The emails may be encrypted within the firewall 208 by the mail server 124 and decrypted at the wireless device 102.

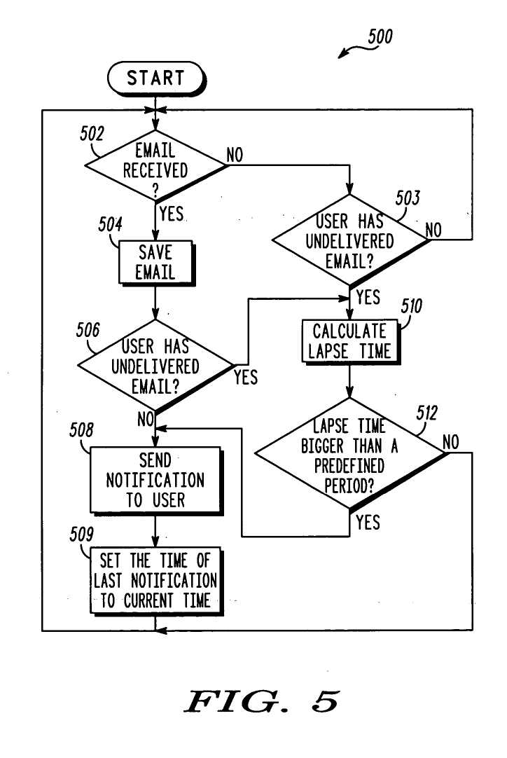

FIG. 5 is a flow chart 500 for the relay server 116 receiving an incoming electronic mail. The relay server 116 checks whether an email destined to a user has been received, step 502, if it has received an email, it saves the email, step 504, and checks whether there is undelivered emails addressed to the user, step 506. If there is no undelivered email, the relay server 116 sends a notification to the user, step 508, and sets the time of last notification sent to current time, step 509. If there is undelivered emails, the relay server 116 calculates the lapse time between the last notification and the current time, step 510. If the lapse time is greater than a predefined period, step 512, the relay server 116 will send a new notification to the wireless device 102, step 508. If the lapse time is not greater than the predefined period, then no notification is sent to the wireless device 102.

Even when the relay server 116 has not received any new incoming email, the relay server 116 checks periodically whether there are any undelivered emails destined to the user on the relay server 116, step 503. If there are undelivered emails, the relay server 116 proceeds to calculate the lapse time, step 510, and decides whether to send another notification to the user.

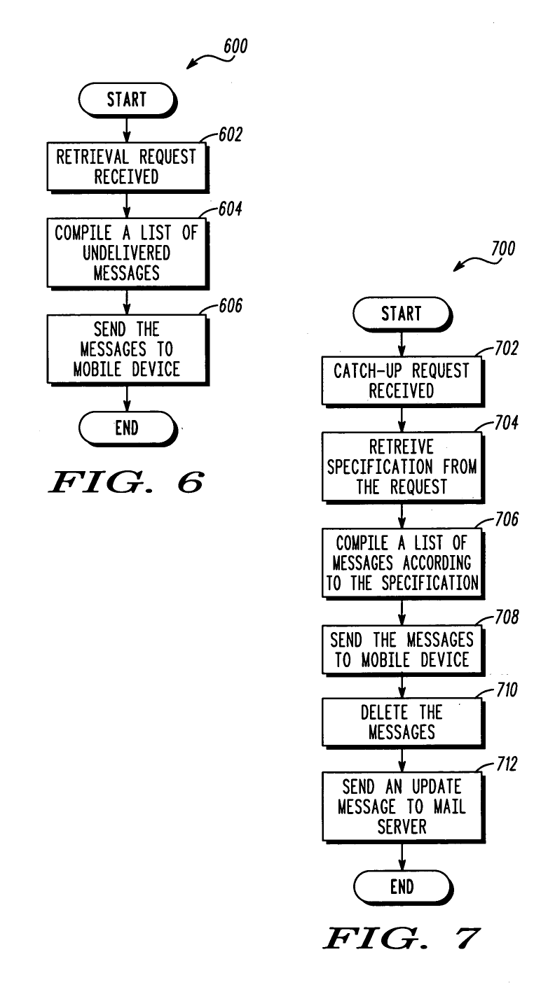

FIG. 6 is a flow chart 600 for the relay server 116 receiving a retrieval request. When a user is ready to retrieve his email, the wireless device 102 sends a retrieval request to the relay server 116, and the relay server 116 receives the retrieval request, step 602. The relay server 116 compiles a list of undelivered emails, step 604, and sends the list to the wireless device 102, step 606. After the emails are delivered, they may be deleted from the relay server 116.

FIG. 7 is a flow chart 700 for the relay server 116 receiving a catch-up request. The user may request a list of the email messages in the relay server 116 that satisfied a certain criteria be transmitted to his wireless device 102 by sending a catch-up request to the relay server 116. The user may specify the criteria, for example if he has been away from his desk for many days, he may wish to receive only emails arrived in last five days, he may wish to receive only or emails from a particular sender. After a catch-up request is received, step 702, the relay server 116 retrieves the specification from the request, step 704. After retrieving the specification, the relay server 116 compiles a list of email messages according to the specification, step 706, and sends the email messages to the wireless device, step 708. After sending the email messages to the wireless device, the relay server deletes them, step 710, and sends an update message to the mail server, step 712. The update message enables the mail server to update the status of the emails accordingly, i.e., the status of the emails is changed from UNREAD to READ.

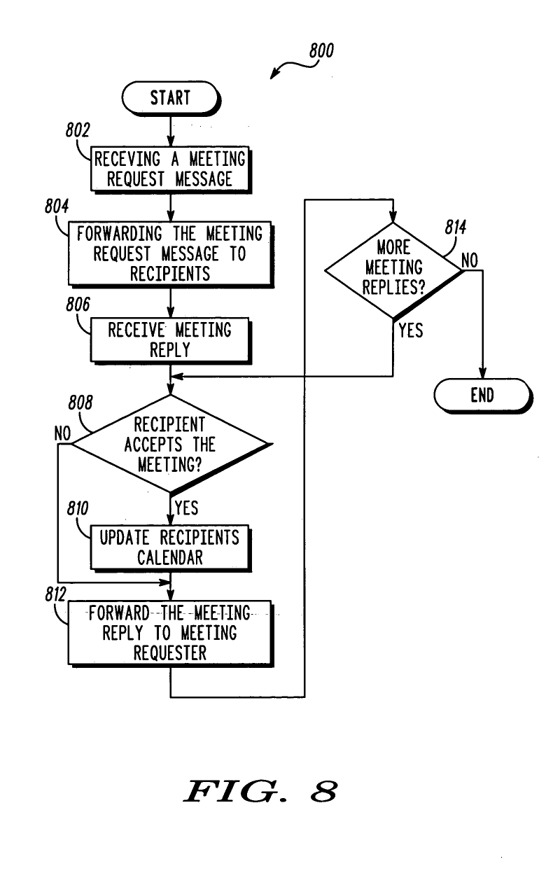

The mail server 124 can optionally handle calendar files for the users. The mail server 124 distinguishes an electronic mail message from meeting related messages and handles them differently. When a user is away from his computer, he can still request a meeting with other parties through use of his wireless handset. He can send a meeting request message to a plurality of parties and he can also receive a meeting request message at his wireless device. FIG. 8 is a flow chart 800 for the mail server 124 receiving a meeting request message. The mail server 124 receives the meeting request message, step 802, and sends the message to each party, step 804. If the user has set up a forwarding option at his desktop computer, the mail server 124 will then forward the message to the user's wireless device.

After receiving the meeting request message, the receiving parties may reply to the message with individual responses as to whether they will be able to attend the meeting. A receiving party may accept the meeting, reject the meeting, tentatively accept the meeting, or forward the meeting request message to another party. If the receiving party accepts the meeting, a meeting entry is added to the calendar file on his wireless device.

When a response (meeting reply) is received by the mail server, step 806, and the mail server 124 checks whether the party has accepted the meeting, step 808. The mail server 124 checks the message through a header tag and a command tag associated with the message. Each message has a unique header tag to indicate the nature of the message. If a party has accepted the meeting, the mail server 124 updates the calendar file for the party by adding the meeting to the calendar file, step 810, and forwards the meeting reply to the user who requested the meeting, step 812. The mail server 124 checks whether there are more replies, step 814, if so, steps 808-812 are repeated.

The following is a use scenario for one embodiment of the present invention. When an email destined for a user arrives at the relay server, the relay server stores the email. Instead of sending one notification for each arriving email, thus cluttering the network traffic, the relay server checks whether the user is actively reading his email. If there is no pending undelivered email on the relay server, it is an indication that the user has read all his emails, and a notification about the new arriving email will be sent to the user. If there are undelivered emails on the relay server, which means that user is not actively reading his emails, the relay server checks whether it has been awhile since the last notification was sent to the user. If the lapse time between the last notification and the current time is greater than a predefined period, the relay server will send a new notification to the user. If the lapse time is not greater than the predefined period, which means that a notification was sent recently to the user, the relay server will not send a new notification to the user. By avoiding sending unnecessary notifications to the wireless device, the traffic volume on a network and user cost can be reduced.

A user may also request a list of his emails be sent to him. This feature allows the user to pick up any messages that he may have missed due to corrupted or missing notification messages, and thereby making the system more fault tolerant. After receiving the list, the user may request all undelivered emails. The wireless device sends this retrieval request to the relay server, and the relay server will send him all undelivered emails.

A user may also request the relay server to send him all of the emails received over a certain period of time. This allows the user to catch-up on messages that might have arrived during a period when the user turned off the wireless device. For example, the user may specify that he wants to read all emails received yesterday. After receiving this catch-up message, the relay server sends a list of emails according to the specification to the wireless device. Alternatively, the user may also specify that he only wants to receive emails sent by his boss since yesterday, and all the emails sent by his boss since yesterday will be sent to user's wireless device.

The relay server can also change the status of emails on the mail server. After sending the emails to the user's wireless device, the relay server deletes the emails and sends an update message with a list of emails back to the mail server. The mail server can then mark the corresponding emails as read.

In view of the method being executable on a mail server that may belong to a wireless service provider or on a wireless communications device, the present invention includes a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of the invention, the method may be implemented, for example, by operating portion of the wireless network to execute a sequence of machine-readable instructions, such as wireless communications device or the server. The instructions can reside in various types of signal-bearing or data storage primary, secondary, or tertiary media. The media may include, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

1. A method for a relay server to provide an electronic mail notification to a mobile device, wherein the mobile device is in communication with the relay server via a wireless communication network, the mobile device communicating with the relay server according to a predefined protocol, the method comprising the steps of:
receiving an electronic mail destined to the mobile device from a mail server;
saving the received electronic mail on the relay server;
if there is no undelivered electronic mail destined to the mobile device on the relay server, then sending a new message notification to the mobile device, marking the received electronic mail as undelivered, and setting the time of last new message notification to the current time;
if there is at least one undelivered electronic mail destined to the mobile device at the relay server, calculating a lapse time between the time of last new message notification sent to the mobile device and the current time; and
if the lapse time is greater than a predefined period, then sending a new message notification to the mobile device, marking the received electronic mail as undelivered, and setting the time of last new message notification to the current time.

2. The method of claim 1, further comprising the steps of:
receiving an electronic mail retrieval request from the mobile device; and
transmitting undelivered electronic mails on the relay server to the mobile device.

3. The method of claim 2, further comprising the steps of:
deleting electronic mails transmitted from the server to the mobile device; and
sending an update message to a mail server.

4. The method of claim 1, further comprising the steps of:
receiving a catch-up request from the mobile device;
retrieving a specification from the catch-up request;
compiling a list of electronic mails according to the specification; and
transmitting the list of electronic mails to the mobile device.

5. The method of claim 4, wherein the specification includes a sender name.

6. The method of claim 4, wherein the specification includes a time period.

7. The method of claim 1, wherein the electronic mail is encrypted at the mail server.

8. The method of claim 1, wherein the electronic mail is decrypted at the mobile device.

9. A method for a relay server to provide a list of electronic mails to a mobile device according to a request received from the mobile device, wherein the mobile device is in communication with the relay server via a wireless communication network, the mobile device communicating with the relay server according to a predefined protocol, the method comprising the steps of:
receiving a request for electronic mails from a user at the mobile device, the request including a specification, wherein electronic mails that accord to the specification are desired by the user;
compiling a list of electronic mails according to the specification; and
transmitting the list of electronic mails to the mobile device.

10. The method of claim 9, wherein the specification includes a sender name.

11. The method of claim 9, wherein the specification includes a time period.

12. The method of claim 9, wherein the specification is for all undelivered electronic mails.

13. A method for scheduling a meeting for a user using a mobile device, wherein the mobile device is in communication with a server via a wireless communication network, the method comprising the steps of:
receiving a meeting request message from the mobile device, the meeting request message containing a request for a meeting and being destined to at least one recipient;
forwarding the meeting request message to the at least one recipient;
receiving a meeting reply message from the at least one recipient;
if at least one recipient has accepted the meeting, then adding the meeting to a calendar file for the at least one recipient; and
forwarding the meeting reply message to the mobile device.
